(19) United States
(12) Patent Application Publication
(10) Pub. No.: US 2005/0139590 A1
(43) Pub. Date: Jun. 30, 2005

(54) Electric heater assembly

(76) Inventor: Kevin Ronald McWillliams, Stratford Upon Avon (GB)

Correspondence Address: Ira S Dorman, Suite 200, 330 Roberts Street, East Hartford, CT, 06108, US

(21) Appl. No.: 10/504,395

(22) PCT Filed: Feb. 12, 2003
(86) PCT No.: PCT/GB03/00577

(30) Foreign Application Priority Data
Feb. 19, 2002 (GB) 0203826.3

(51) Int. Cl. H05B 3/02

(52) U.S. Cl. 219/483

(57) ABSTRACT

An electric heater assembly (2) for a smooth top cooking appliance comprises first and second heating zones (16 and 18) provided with first and second heating elements (20 and 22), respectively, the second heating zone (18) at least partially surrounding the first heating zone (16). First and second energy controllers (26 and 32) energise the first and second heating elements (20 and 22), respectively, from a power supply (28). The first heating zone (16) is operable alone with the first cyclic energy controller (26) controlling power of the first heating element (20) at selected settings between a maximum duty cycle and a minimum duty cycle. The first and second heating zones (16, 18) are operable together such that, in a selected full power operating condition of the assembly, the second cyclic energy controller (32) energises the second heating element (22) at substantially maximum duty cycle to provide a substantially maximum power in the second heating zone (18), and the first cyclic energy controller (26) energises the first heating element (20) at less than maximum duty cycle to provide less than maximum power in the first heating zone (16).

This invention relates to electric heater assemblies for smooth top cooking appliances, particularly such appliances having glass-ceramic cooking surfaces.

More particularly, the invention relates to such heater assemblies having heating elements arranged and connected such that separate heating zones are provided, namely a first heating zone at least partially surrounded by at least one second heating zone. A wall of thermal insulation material is known to be provided to separate the heating zones.

The first heating zone usually comprises a main heating zone which can be operated alone. The at least one second heating zone comprises an auxiliary heating zone which is arranged to be operated together with the first heating zone. The heating zones may be operated by way of a cyclic energy regulator.

In a known arrangement, the first heating zone is circular and is arranged concentrically with a surrounding second heating zone. In a further known arrangement, a circular first heating zone is bordered by a substantially crescent-shaped second heating zone, to form an overall oval arrangement, or is bordered on either side with two wing-like second heating zones, to form what is commonly referred to as an ‘angel’ arrangement.

There is known, for example from EP-A-0 892 584, an electric heater assembly in which, when the first, or main, heating zone is operated with the second, or auxiliary, heating zone, in a full power setting the specific surface power loading in the first zone is at least as great as the specific surface power loading in the second zone, while in a lower power setting the specific surface loading in the first zone is not greater than the specific surface power loading in the second zone. That is the relative powers of the first and second zones are adapted according to the power level setting of the heater assembly.

When the first, or main, heating zone is operated alone, it is desirable that operation should be at optimum maximum power in order to provide maximum efficiency of operation, such as for boiling a liquid in a cooking vessel overlying the first heating zone. However, when this heating zone is operated with the second, or auxiliary, heating zone, the first heating zone may provide excessively high power relative to the second heating zone, leading to unsatisfactory heat distribution in the heater assembly. In the case of a concentric arrangement of the first and second heating zones, high power in the main central heating zone relative to the auxiliary outer heating zone provides what is known as a centre-weighted heat distribution, which can be undesirable.

In order to deal with this problem, it is known, for example from EP-A-0 551 172, to provide an arrangement in which a further heating element is located with the heating element or elements in the outer heating zone of a heater assembly having a concentric arrangement of central and outer heating zones. When the central and outer zones are operated together, the heating element or elements in the central heating zone is or are arranged to be electrically connected in series with the further heating element provided in the outer heating zone. This reduces the power in the central heating zone to an acceptable level, but allows the optimum full power of the central heating zone to be obtained when the central heating zone is operated alone, without the heating element or elements therein being connected in series with the further heating element. However, such an arrangement is complex and expensive to implement.

It is an object of the present invention to overcome or minimise this problem.

According to the present invention there is provided an electric heater assembly for a smooth top cooking appliance, the assembly comprising a first heating zone provided with at least one first heating element, and at least one second heating zone provided with at least one second heating element, the at least one second heating zone at least partially surrounding the first heating zone, and a cyclic energy regulator for energising the heating elements from a power supply, wherein a first cyclic energy controller is provided adapted to energise the at least one first heating element and a second cyclic energy controller is provided adapted to energise the at least one second heating element, wherein the assembly is adapted whereby the first heating zone is operable alone with the first cyclic energy controller controlling power of the at least one first heating element at selected settings between a maximum duty cycle and a minimum duty cycle, and wherein the assembly is further adapted whereby the first and the at least one second heating zones are operable together and such that in a selected full power operating condition of the assembly the second cyclic energy controller energises the at least one second heating element at substantially maximum duty cycle to provide a substantially maximum power in the at least one second heating zone, and the first cyclic energy controller energises the at least one first heating element at less than maximum duty cycle to provide less than maximum power in the first heating zone.

The heater assembly may be still further adapted whereby the first and second heating zones are operable together such that, at selected operating power conditions of the heater assembly, lower than the full power operating condition, a predetermined ratio is arranged between the duty cycle provided by the first cyclic energy controller and the duty cycle provided by the second cyclic energy controller.

The predetermined ration may be fixed. In such a case, the predetermined ratio may be that obtaining at the full power operating condition of the heater assembly and may be maintained down to a low power operating condition of the heater assembly limited by a minimum duty cycle achievable by the first cyclic energy controller. When such low power operating condition of the heater assembly is reached, a lower power operating condition of the heater assembly may be obtained by maintaining, at its minimum value, the duty cycle set by the first cyclic energy controller and further reducing the duty cycle provided by the second cyclic energy controller whereby a further predetermined ratio is established between the duty cycles provided by the first and second cyclic energy controllers.

In an alternative arrangement, the predetermined ratio may be variable. In such a case, the ratio may be arranged to vary in predetermined manner whereby it is gradually changed from an initial value, obtaining at the full power operating condition of the heater assembly, to a final value, obtaining at a lowest power operating condition of the heater assembly. The final value of the ratio may be substantially unity, achieved by operating both the first and the second cyclic energy controllers to provide substantially minimum and matched duty cycles.

In the selected full power operating condition of the heater assembly, the second cyclic energy controller may be arranged to energise the at least one second heating element at substantially 100 percent duty cycle, with the first cyclic energy controller arranged to energise the at least one first heating element at about 80 percent duty cycle.

The first and second cyclic energy controllers may comprise first and second cycling energy regulators or first and second cycling relays.

The first and second cyclic energy controllers may be operated by a microprocessor-based control system which may be associated with manual input selection means.

The first heating zone may comprise a main heating zone, with the at least one second heating zone comprising at least one auxiliary heating zone.

The first heating zone may be circular and arranged concentrically with and surrounded by one or more second heating zones.

Alternatively, the first heating zone may be circular and partially bordered by one or two second heating zones.

The first and second heating zones may be separated by a wall of thermal insulation material.

The smooth top cooking appliance may comprise a glass-ceramic cooking surface.

By means of the present invention, an electric heater assembly is provided in which a first, or main, heating zone is operable alone at optimum power, but is automatically reduced in simple manner to a desired lower power when operated together with at least one associated second, or auxiliary, heating zone. Furthermore, a desired ratio between the heating powers of the first and second heating zones is readily obtained, at selected settings of the heater assembly, over the operating range of the heater assembly.

For a better understanding of the present invention and to show more clearly how it may be carried into effect, reference will now be made, by way of example, to the accompanying drawings in which:

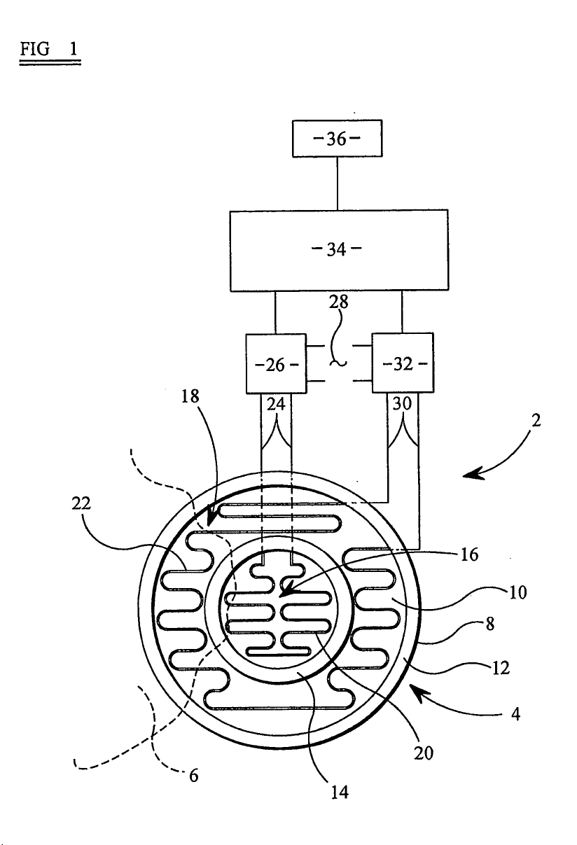

FIG. 1 is a schematic plan view of an embodiment of an electric heater assembly according to the present invention; and

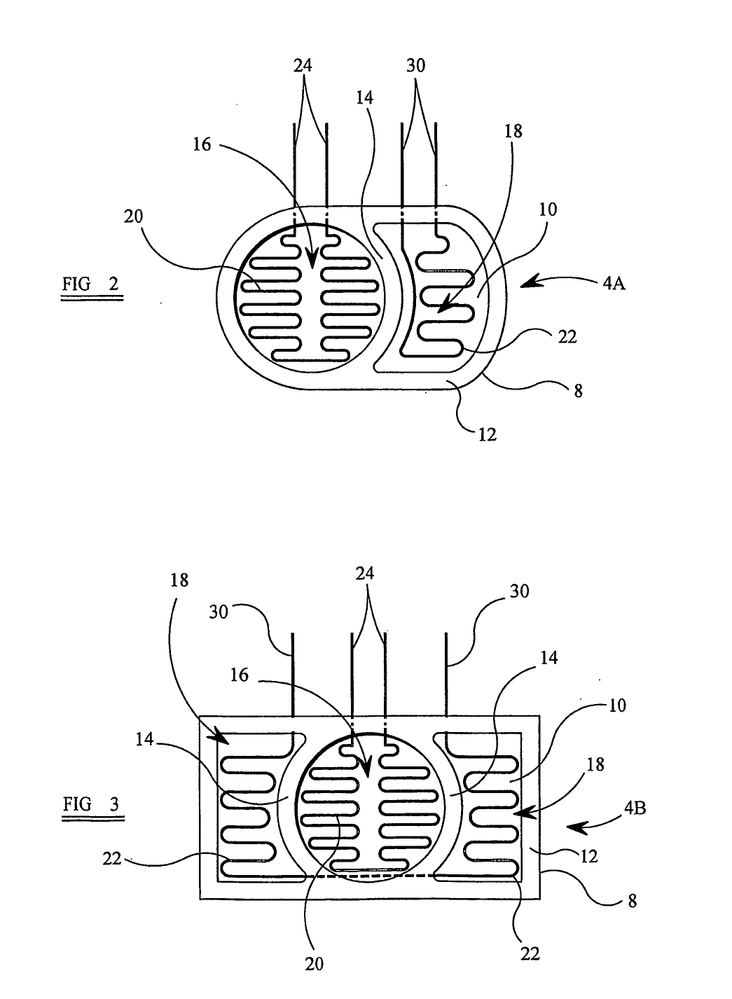

FIGS. 2 and 3 are plan views of alternative heater arrangements for use in the assembly of FIG. 1.

In an electric heater assembly 2, a radiant electric heater 4 is provided for location beneath a glass-ceramic cooking surface 6 in a cooking appliance. The heater 4 has a metal dish 8 containing a layer 10 of thermal and electrical insulation material, such as microporous thermal and electrical insulation material. A ring-shaped wall 12 of thermal insulation material extends peripherally around the heater and a ring-shaped inner wall 14 is optionally provided concentrically with the peripheral wall 12.

Two concentric heating zones are provided in the heater, a first main heating zone 16 being surrounded by a second auxiliary heating zone 18. A first heating element 20 of well known form is arranged in the first heating zone 16 and a second heating element 22 of well known form is similarly arranged in the second heating zone 18. Multiple first and second heating elements 20, 22 could be provided in the first and second heating zones 16, 18, if desired.

The first heating element 20 is electrically connected by leads 24 to a first cyclic energy controller 26, by means of which the first heating element 20 is energised from a power supply 28.

The second heating element 22 is electrically connected by leads 30 to a second cyclic energy controller 32, by means of which the second heating element 22 is energised from the power supply 28.

The first and second cyclic energy controllers 26, 32 comprise first and second cycling energy regulators or first and second cycling relays. They are arranged to be operated by a microprocessor-based control system 34 which is associated with a manual input selection means 36 by means of which desired power settings of the heater 4 can be entered and also selection of the heating elements for energising.

The heater assembly 2 is arranged whereby the first heating element 20 can be energised alone, to operate only the first heating zone 16, or can be energised together with the second heating element 22, to operate both the first and the second heating zones 16 and 18. When the first heating zone 16 is operated alone, the first cyclic energy controller 26 operates to control the power of the first heating element 20, at selected settings of the input selection means 36, between a maximum duty cycle and a minimum duty cycle. Full power of the first heating element 20 is arranged at maximum duty cycle of the first cyclic energy controller 26 and is arranged to provide optimum heating performance of the first heating zone 16 when a cooking vessel (not shown) is located on the cooking surface 6 overlying the first heating zone 16.

When the first and second heating zones 16, 18 are operated together, it is arranged that in a selected full power operating condition of the assembly 2 the second cyclic energy controller 32 energises the second heating element 22 at substantially maximum duty cycle, namely 100 percent duty cycle, to provide a substantially maximum power in the second heating zone 18. At the same time, in this operating condition of the assembly 2, the first cyclic energy controller 26 is arranged to energise the first heating element 20 at less than maximum duty cycle to provide less than maximum power in the first heating zone 16. Such less than maximum duty cycle may be suitably about 80 percent duty cycle. In the absence of such reduction in power in the first heating zone 16, the maximum power available in the first heating zone 16 would result in the first heating zone 16 being much hotter than the second heating zone 18, resulting in the heater 4 having a heat distribution undesirably weighted towards the centre. By means of the reduction in power in the first heating zone 16, a better heat distribution is achieved.

A further feature of the heater assembly 2 is available when the first and second heating zones 16, 18 are operated together. It is provided that as operating power conditions of the heater assembly 2 lower than the full power operating condition are selected, a predetermined fixed or varying ratio is arranged between the duty cycle provided by the first cyclic energy controller 26 and the duty cycle provided by the second cyclic energy controller 32. The predetermined ratio can be that obtaining at the full power operating condition of the heater assembly 2 and can be substantially fixed and maintained down to a low power operating condition of the heater assembly 2 limited by a minimum duty cycle achievable by the first cyclic energy controller 26. When such low power operating condition of the heater assembly 2 is reached, a lower power operating condition of the heater assembly 2 can be obtained by maintaining, at its minimum value, the duty cycle set by the first cyclic energy controller 26 and further reducing the duty cycle provided by the second cyclic energy controller 32, whereby a further predetermined ratio is established between the duty cycles provided by the first and second cyclic energy controllers 26, 32. This enables a lower overall minimum power to be obtained from the heater assembly 2, although the heat distribution would become more weighted towards the centre of the heater. Since the power is low, this is unlikely to adversely affect cooking performance on the heater 4.

In an alternative arrangement, the ratio between the duty cycles provided by the first and second cyclic energy controllers 26 and 32 can be arranged to vary in predetermined manner whereby the ratio is gradually changed from an initial value, obtaining at the selected full power operating condition of the heater assembly 2, to a final value obtaining at the selected lowest power operating condition of the heater assembly 2. The final value of the ratio can be arranged to be substantially unity, achieved by operating both the first and the second cyclic energy controllers 26 and 32 to provide substantially minimum and matched (i.e. the same) duty cycles.

The heater assembly 2 of the present invention is not limited to the heater 4 having a concentric arrangement of first 16 and second 18 heating zones. As shown in FIG. 2, an alternative heater 4A for use in the assembly 2 of FIG. 1 comprises an oval metal dish 8 with a layer 10 of thermal insulation material. A first main heating zone 16, having a first heating element 20, is bordered by a crescent-shaped second auxiliary heating zone 18, having a second heating element 22. A peripheral wall 12 of thermal insulation material is provided and a further wall portion 14 of thermal insulation material divides the two heating zones 16, 18. The first heating element 20 has leads 24 for connection to the first cyclic energy controller 26 of FIG. 1 and the second heating element 22 has leads 30 for connection to the second cyclic energy controller 32 of FIG. 1. Operation of the resulting heater assembly is substantially the same as that previously described with reference to FIG. 1.

As shown in FIG. 3, a further alternative heater 4B for use in the assembly 2 of FIG. 1 is similar to that shown in FIG. 2 with the exception that two second auxiliary heating zones 18 are provided bordering a first main heating zone 16. Heating elements 22 in the second heating zones 18 are connected in series or in parallel and have leads 30 for connection to the second cyclic energy controller 32 of FIG. 1. Heating element 20, in the first heating zone 16, has leads 24 for connection to the first cyclic energy controller 26 of FIG. 1.

1. An electric heater assembly for a smooth top cooking appliance, the assembly comprising a first heating zone (16) provided with at least one first heating element (20), and at least one second heating zone (18) provided with at least one second heating element (22), the at least one second heating zone at least partially surrounding the first heating zone, and a cyclic energy regulator (26, 32) for energising the heating elements from a power supply (28), wherein a first cyclic energy controller (26) is provided adapted to energise the at least one first heating element (20) and a second cyclic energy controller (32) is provided adapted to energise the at least one second heating element (22), and wherein the assembly is adapted whereby the first heating zone (16) is operable alone with the first cyclic energy controller (26) controlling power of the at least one first heating element (16) at selected settings between a maximum duty cycle and a minimum duty cycle, and wherein the assembly is further adapted whereby the first and the at least one second heating zones (16, 18) are operable together and such that in a selected full power operating condition of the assembly the second cyclic energy controller energises the at least one second heating element at substantially maximum duty cycle to provide a substantially maximum power in the at least one second heating zone, and the first cyclic energy controller energises the at least one first heating element at less than maximum duty cycle to provide less than maximum power in the first heating zone.

2. An assembly as claimed in claim 1, wherein the heater assembly is further adapted whereby the first and second heating zones (16, 18) are operable together such that, at selected operating power conditions of the heater assembly, lower than the full power operating condition, a predetermined fixed or varying ratio is arranged between the duty cycle provided by the first cyclic energy controller and the duty cycle provided by the second cyclic energy controller.

3. An assembly as claimed in claim 2, wherein the ratio is fixed.

4. An assembly as claimed in claim 3, wherein the predetermined ratio is that obtaining at the full power operating condition of the heater assembly.

5. An assembly as claimed in claim 3, wherein the predetermined ratio is maintained down to a low power operating condition of the heater assembly limited by a minimum duty cycle achievable by the first cyclic energy controller (26).

6. An assembly as claimed in claim 5, wherein, when such low power operating condition of the heater assembly is reached, a lower power operating condition of the heater assembly is obtained by maintaining, at its minimum value, the duty cycle set by the first cyclic energy controller (26) and further reducing the duty cycle provided by the second cyclic energy controller (32) whereby a further predetermined ratio is established between the duty cycles provided by the first and second cyclic energy controllers.

7. An assembly as claimed in claim 3, wherein the ratio is variable.

8. An assembly as claimed in claim 7, wherein the ratio is arranged to vary in predetermined manner whereby it is gradually changed from an initial value, obtaining at the full power operating condition of the heater assembly, to a final value, obtaining at a lowest power operating condition of the heater assembly.

9. An assembly as claimed in claim 8, wherein the final value of the ratio is substantially unity, achieved by operating both the first and second cyclic energy controllers (26, 32) to provide substantially minimum and matched duty cycles.

10. An assembly as claimed in claim 1 wherein, in the selected full power operating condition of the heater assembly, the second cyclic energy controller (32) is arranged to energise the at least one second heating element (22) at substantially 100 percent duty cycle, with the first cyclic energy controller (26) arranged to energise the at least one first heating element (20) at about 80 percent duty cycle.

11. An assembly as claimed in claim 1, wherein the first and second cyclic energy controllers (26, 32) are selected from energy controllers comprising first and second cycling energy regulators and energy controllers comprising first and second cycling relays.

12. An assembly as claimed in claim 1, wherein the first and second cyclic energy controllers (26, 32) are operated by a microprocessor-based control system (34).

13. An assembly as claimed in claim 12, wherein the microprocessor-based control system (34) is associated with manual input selection means (36).

14. An assembly as claimed in claim 1, wherein the first heating zone (16) comprises a main heating zone, with the at least one second heating zone (18) comprising at least one auxiliary heating zone.

15. An assembly as claimed in claim 14, wherein the first heating zone (16) is circular and arranged concentrically with and surrounded by one or more at least one second heating zones (18).

16. An assembly as claimed in claim 14, wherein the first heating zone (16) is circular and partially bordered by one or two at least one second heating zones (18).

17. An assembly as claimed in claim 1, wherein the first and second heating zones (16, 18) are separated by a wall (14) of thermal insulation material.
